(19) United States
(12) Patent Application Publication
(10) Pub. No.: US 2026/0307840 A1
(43) Pub. Date: Oct. 8, 2026

(54) SINGLE-CHAMBER BALER DEVICE AND METHOD FOR FORMING AND PACKAGING BALES BY MEANS OF SUCH A DEVICE

(71) Applicant: VALVAN NV, Menen (BE)

(72) Inventors: Marc VANDOORNE, Menen (BE); Steven D'HAENE, Menen (BE)

(21) Appl. No.: 19/111,197

(22) PCT Filed: Oct. 17, 2023
(86) PCT No.: PCT/IB2023/060462

§ 371 Date: Mar. 12, 2025

(30) Foreign Application Priority Data
Oct. 17, 2022 (BE) 2022/5835

(51) Int. Cl. B65B 27/12; B65B 11/02

(52) U.S. Cl. CPC B65B 27/125; B65B 11/025

(57) ABSTRACT

Disclosed is a single-chamber baler device intended for forming and, by way of a packaging material, packaging bales composed of a compressible material in the form of natural and/or synthetic fibers. The device includes comprising a pressing and packaging zone configured for receiving the material, a top ram and a bottom ram, where the material is formed into a bale in the pressing and packaging zone between the top ram and the bottom ram, and a packaging device for packaging a bale, where the packaging device includes a film wrapper which is rotatable clockwise and anticlockwise and which is intended for packaging one part of the bale by way of anticlockwise rotation of the film wrapper around the bale and for packaging another part of the bale by way of clockwise rotation of the film wrapper around the bale.

This application is a National Phase entry of International Application No. PCT/IB2023/060462 under § 371 and claim the benefit of Belgium Patent Application No. BE 2022/5835 filed on Oct. 17, 2022, which is hereby incorporated by reference in its entirety.

### FIELD OF THE DISCLOSURE

The present disclosure relates to a single-chamber baler device for forming a bale and packaging it by way of a packaging material. The single-chamber baler device according to the disclosure is in particular equipped to automatically package a bale and to subsequently automatically tie the latter using a tying material.

The present disclosure furthermore relates to a method for forming and packaging bales with the aid of such a single-chamber baler device.

### BACKGROUND

Single-chamber balers in which the fed material is pressed into a bale vertically between a top ram and a bottom ram are known per se and exist in different embodiments. Such single-chamber baler devices compress a compressible material, such as for example natural and synthetic fibers, paper, cardboard, foam, plastic and the like, into bales in a pressing zone by way of a pressing force of between 50 and 5000 kN.

In order to prevent loss of material and/or contamination of the compressed material, to maintain the dimensional stability of the bale and to protect the bale from for example moisture, the bales will be provided with a packaging material after compression. This may be a sheet material which, for example, is made of cardboard, but may also be a flexible material, such as for example a plastic film or fabric. After packaging, the formed bales may be tied manually or automatically with the aid of for example a strap-shaped or wire-shaped material which may be made of iron, steel or plastic.

At present, the packaging material is often applied manually- and this after a previous bale has been removed (manually or automatically) from the pressing zone-in the form of two covers which, prior to the feeding of the compressible material into the pressing chamber, are provided at the top ram and the bottom ram.

The manual application of the packaging material has the disadvantage that this entails high cost in terms of time, as a result of which the capacity of such a single-chamber baler device is limited to approximately 7 bales per hour. An additional disadvantage of manual packaging is that one or even two workers are required for applying the packaging material, which entails high labor costs.

US 2016/0318640 describes a rotary packaging device which is specifically suitable for packaging bales which are compressed in a baler device made up of a pre-press and a main press, wherein the pre-compressed material is moved to the main press via a connecting channel. Such a packaging device, on account of the limited available space, is not suitable for use in combination with a single-chamber baler device.

### SUMMARY

An object of the present disclosure is to provide a single-chamber baler device which makes fully automatic packaging of bales in the single-chamber baler device possible for the user, as a result of which the capacity of a single-chamber baler device can be increased. In association with this, an object of the present disclosure is to provide a method for fully automatic packaging of bales and for the latter to be subsequently tied automatically in a single-chamber baler device using a tying material.

An object of the disclosure is achieved by providing a single-chamber baler device intended for forming and, by way of a packaging material, packaging bales composed of a compressible material in the form of natural and/or synthetic fibers, comprising a pressing and packaging zone, a packaging device configured for packaging a bale in the pressing and packaging zone, a top ram and a bottom ram, wherein the material is formed into a bale in the pressing and packaging zone between the top ram and the bottom ram, wherein the pressing and packaging zone is provided with an outfeed side along which a packaged bale exits the pressing and packaging zone, and wherein the packaging device comprises a film wrapper which is rotatable clockwise and anticlockwise and which is intended for packaging one part of the bale by way of anticlockwise rotation of the film wrapper around the bale and for packaging another part of the bale by way of clockwise rotation of the film wrapper around the bale, wherein the film wrapper is rotatable anticlockwise at least between a start position and a delivery position, and is rotatable clockwise between the delivery position and an end position, wherein the single-chamber baler device comprises a vertically adjustable press compartment with a number of press-chamber walls, wherein the adjustable press compartment can be adjusted between a pressing position, in which compressible material can be compressed in the pressing and packaging zone between the top ram, the bottom ram and the press-chamber walls of the press compartment prior to the formation of a bale, and a packaging position, in which the side walls of the bale formed in the pressing and packaging zone are accessible to the packaging device, and wherein the start position of the film wrapper is situated on the side situated opposite the outfeed side of the pressing and packaging zone. The press compartment is a preferably one-part tubular housing with an open bottom side and an open top side that is formed by a number of wall panels which have been welded together, namely press-chamber walls. Preferably, the press compartment is movable up and down. The bale is formed in the press compartment when the press compartment is in its pressing position, in a lowered position. Once the bale has been formed, the press compartment moves upwards to a packaging position, where the side walls (sides), namely the four upright walls, of the formed bale—which is still situated in the pressing and packaging zone—can then be packaged with the aid of the film wrapper.

By positioning the film wrapper in such a way that, in its start position, it is positioned opposite the outfeed side along which the packaged (and possibly tied) bale will exit the pressing and packaging zone of the baler device, the film wrapper does not form an obstacle for the press compartment able to be moved up and down.

Such a single-chamber baler device has the advantage that the formation and packaging of the bale can proceed in a fully automatic manner. The single-chamber baler device is consequently suitable for forming and packaging bales at a high capacity, preferably 10 to 15 bales per hour. The bales have as standard the following dimensions (1×b×h): 1140×740×950/1150 cm. The bale weight is dependent on the type of material and the pressing force and between 200 and 320 kg.

In a preferred embodiment of the single-chamber baler device according to the disclosure, the packaging device comprises a rotary ring mounted below the bottom ram, wherein the film wrapper is connected to the rotary ring for clockwise and anticlockwise rotation of the film wrapper. Mounting the rotary ring below the bottom ram makes possible rotation of the rotation wrapper in a compact manner. This is advantageous for a single-chamber baler device in which the available space for provision of a packaging device is limited. The rotary ring is mounted on a bottom frame which forms part of the single-chamber baler according to at least one embodiment the invention.

In a preferred embodiment of the single-chamber baler device according to the disclosure, the packaging device furthermore comprises a driver for driving the rotary ring. Owing to the fact that the driver drives the rotary ring, and thus do not directly drive the film wrapper, the film wrapper can be kept relatively compact. Owing to the fact that the film wrapper furthermore need not comprise a driver, the film wrapper remains relatively light, as a result of which the rotary ring, and thus the film wrapper, can be driven in an energy-efficient manner.

The press compartment is preferably vertically adjustable. When compressible material is fed to the press compartment, the press compartment is situated at the bottom of the press device in the pressing and packaging zone. In this position, namely the pressing position, the bottom ram and the press-chamber walls of the press compartment almost abut against one another. The bottom ram, the top ram and the press compartment thus form a press chamber. Prior to the packaging of the bale, the press compartment is then raised in such a way that the upright walls (or edges) of the bale can be packaged by the packaging device.

In a preferred embodiment of the single-chamber baler device according to the disclosure, the packaging device furthermore comprises guiders which are intended for guiding the packaging material through the film wrapper during rotation of the film wrapper around the bale. The guiders ensure that, during the rotational movement, the packaging material is applied in a taut state around the bale.

The film wrapper is rotatable anticlockwise at least between a start position and a delivery position and is rotatable clockwise between the delivery position and an end position. During the rotation of the film wrapper between the delivery position and the end position, it will pass the start position. After the packaging cycle has finished, the film wrapper will return to its start position by rotating anticlockwise. Of course, in an alternative embodiment, the above-described direction of rotation of the rotation wrapper may be reversed because of, for example, the setup of the packaging unit, and the film wrapper is then rotatable clockwise at least between a start position and a delivery position, and is rotatable anticlockwise between the delivery position and an end position. During the rotation of the film wrapper between the delivery position and the end position, it will pass the start position. After the packaging cycle has finished, the film wrapper will return to its start position by rotating clockwise.

In a preferred embodiment of the single-chamber baler device according to the disclosure, the packaging device comprises a linearly movable translation wrapper intended for gripping the packaging material at the location of the delivery position and carrying it along in the direction of the end position of the film wrapper in order to package a part of the bale. It will be clear that “linearly movable” is intended to mean that the translation wrapper performs a substantially rectilinear movement, in contrast to the film wrapper, which performs a substantially circular movement.

In a preferred embodiment of the single-chamber baler device according to the disclosure, the film wrapper is configured for providing packaging material, and wherein the translation wrapper is intended for taking over packaging material from the film wrapper. This offers the advantage that the bale can be packaged more quickly, as a result of which the cycle time is shortened.

In a preferred embodiment of the single-chamber baler device according to the disclosure, the single-chamber baler device furthermore comprises an upper gripping device, fitted in the top ram, and a lower gripping device, fitted in the bottom ram, wherein the upper gripping device and the lower gripping device are configured for gripping packaging material. Preferably, when the upper or lower gripping device is activated, the packaging material is clamped between one of the gripping devices and the bale to be packaged.

In a preferred embodiment of the single-chamber baler device according to the disclosure, the single-chamber baler device furthermore comprises a cutting device intended for cutting the packaging material. More preferably, the film wrapper, at the location of its end position, is movable between the end position and a cutting position.

In a preferred embodiment of the single-chamber baler device according to the disclosure, the single-chamber baler device furthermore comprises a binding device intended for tying the packaged bale using a tying material. The binding device will preferably tie the formed bale using a strap-shaped or wire-shaped tying material, such as for example an iron, steel or plastic wire or strip. The tying will also take place when the packaged bale is situated in the pressing and packaging zone. The binding device, too, comprises guiders. These guiders of the binding device are preferably also provided on the bottom frame of the baler device. The guiders comprise linearly movable carriages and rotary-ring bearings. The fact that both the rotary ring of the packaging device and the guiders of the binding device are mounted on the same frame, namely the bottom frame, means that the packaging device and the binding device can be easily aligned with respect to one another. Such an embodiment also results in a compact setup which is easily accessible for maintenance, for example.

Another subject of the present disclosure relates to a method for forming and packaging bales in a single-chamber baler device as described above, wherein the method comprises the steps as described in the independent method claim.

In a preferred embodiment of the method for forming and packaging bales, step j) is covering the upright surfaces of the formed bale by packaging a part of these surfaces by way of a rectilinear movement of the translation wrapper and by packaging another part of these surfaces by way of a rotational movement of the film wrapper.

### BRIEF DESCRIPTION OF THE DRAWINGS

In order to further illustrate the properties of embodiments of the present invention and to indicate additional advantages and particular features thereof, a more detailed description of the single-chamber baler device with packaging device according to the present disclosure and of the manner in which a bale is packaged with the aid of such a packaging device is now given below. It will be clear that nothing in the following description may be interpreted as a limitation of the protection for embodiments of the present invention as laid down in the claims. In the present description, reference numerals are used to refer to the attached drawing, in which:

FIG. 1 is a schematic cross section of a single-chamber baler device according to at least one embodiment of the invention;

FIG. 2 is a detail illustration of the rotary ring and the rotation wrapper and the driver;

FIG. 3 is a plan view of a preferred embodiment of the single-chamber baler device according to at least one embodiment of the invention.

FIG. 4 shows a perspective illustration of a single-chamber baler device according to at least one embodiment of the invention, wherein the adjustable press compartment is shown in a raised position, namely the packaging position;

FIG. 5 shows the rear side of the baler device shown in FIG. 4;

FIG. 6 shows a perspective illustration of a single-chamber baler device according to at least one embodiment of the invention, wherein the adjustable press compartment is shown in a lowered position, namely the pressing position;

FIG. 7 shows the rear side of the baler device shown in FIG. 6.

### DETAILED DESCRIPTION OF THE DRAWINGS

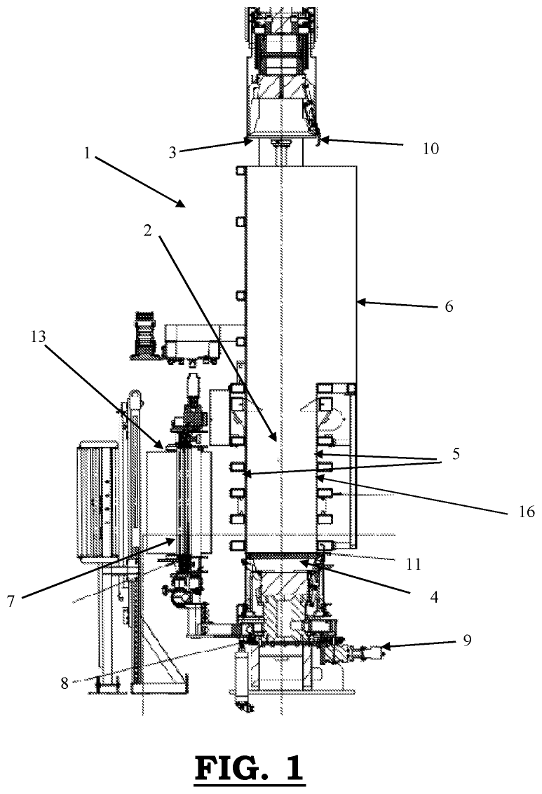

The single-chamber baler device (1) shown in FIG. 1 is suitable for automatic packaging and tying of a bale. The respective device (1) comprises a pressing and packaging zone (2), a top ram (3), a bottom ram (4), a vertically adjustable press compartment (16) and an infeed (6) along which compressible material is fed into the press compartment (16). The adjustable press compartment (16) is a tubular housing constructed from press-chamber walls (5). In FIG. 1, and 7, the press compartment (16) is shown in the pressing position. The pressing and packaging zone is the zone of the baler device (1) where, depending on where the press compartment (16) is situated, either the bale will be pressed or the bale will be packaged and tied. The pressing and packaging zone (2) is provided with an outfeed side (indicated by ref. numeral (15)) along which a packaged and tied bale exits the pressing and packaging zone (2).

Prior to the formation of the bale, the press compartment (16) will be raised to the packaging position. In the packaging position, a bottom sheet of packaging material is provided on the bottom ram (4). Afterwards, the adjustable press compartment (16) descends back to the pressing position. In the pressing position, the pressing and packaging zone (2) is delimited by the walls of the press compartment (16) and the top and bottom rams and compressible material introduced into the pressing and packaging zone (2) via the infeed (6). Afterwards, the top ram (3) is driven in order to carry out a pressing stroke. The introduction of compressible material and the carrying out of a pressing stroke are repeated until the desired amount of compressible material is present in the pressing and packaging zone (2). When a final amount of compressible material is introduced, a top sheet is provided on top of the press compartment (between the press walls and the top ram). Afterwards, a final pressing stroke is carried out, wherein the compressible material is formed into a bale between the top ram (3) and the bottom ram (4). At that point in time, a bottom sheet is situated between the formed bale and the bottom ram (4). A top sheet is situated between the formed bale and the top ram (3).

After the formation of the bale, the adjustable press compartment (16) is raised to the packaging position. Possibly, the top ram (3) continues to exert a certain pressure on the formed bale. Next, the packaging of the bale takes place. For this purpose, the single-chamber baler device (1) comprises a packaging device with a film wrapper (7) connected to a rotary ring (8) mounted below the bottom ram (4). The rotary ring (8), and consequently the film wrapper (7), is driven by a driver, here an electric motor (9). The film wrapper (7) is, for example, firstly rotated anticlockwise from the start position to the delivery position for application of packaging material to a part of the bale. Subsequently, after the translation movement has been performed, the film wrapper (7) is rotated clockwise from the delivery position to the end position for application of packaging material to another part of the bale. Those parts of the bale to which, during the anticlockwise and clockwise rotation of the film wrapper (7) together with the translational movement, packaging material is applied have here a certain overlap, so that the side walls of the bale are completely provided with packaging material. After the application of the packaging material to the bale, the film wrapper (7) moves from the end position to the cutting position (CP). In the cutting position, a cutting device (not shown here) cuts the packaging material.

What is important in this case is that, as can be seen from FIGS. 5 and 7, the film wrapper, as standard, is set up on that side of the baler device which is situated opposite the outfeed side (15) of the pressing and packaging zone (2). The position can be regarded as the above-described start position. This setup makes it possible for the adjustable press compartment (16) to be able to move up and down without any problems.

After the packaging material has been cut through, the bale can also be tied. For this purpose, the packaging device may be equipped with a binding device (not shown here) that is intended for tying the formed bale using a tying material. The binding device will preferably tie the formed bale using a strap-shaped or wire-shaped tying material, such as for example an iron, steel or plastic wire or strip.

The packaging device furthermore comprises an upper gripping device (10), fitted in the top ram (3), and a lower gripping device (11), fitted in the bottom ram (4). The upper gripping device (10) and lower gripping device (11) are configured for gripping packaging material. For example, both gripping devices (10, 11) are activated when the film wrapper (7) is situated at the delivery position. The packaging material applied by the film wrapper (7) is consequently clamped between the gripping devices (10, 11) and the formed bale. The gripping devices (10, 11) thus permit further movement of the film wrapper (7) without the packaging material already applied still being able to move. In addition, the gripping devices (10, 11) can grip the packaging material also after the film wrapper (7) has reached the end position. The packaging material thus remains in place during the movement of the film wrapper (7) from the end position to the cutting position (CP) and the tying of the formed bale.

The film wrapper (7) is provided with packaging material by a rotatable roll holder (13). The rotatable roll holder (13) is provided for receiving a roll of packaging material (14), wherein the roll holder (13) is driveable and is intended for keeping the packaging material tensioned during the packaging of the bale.

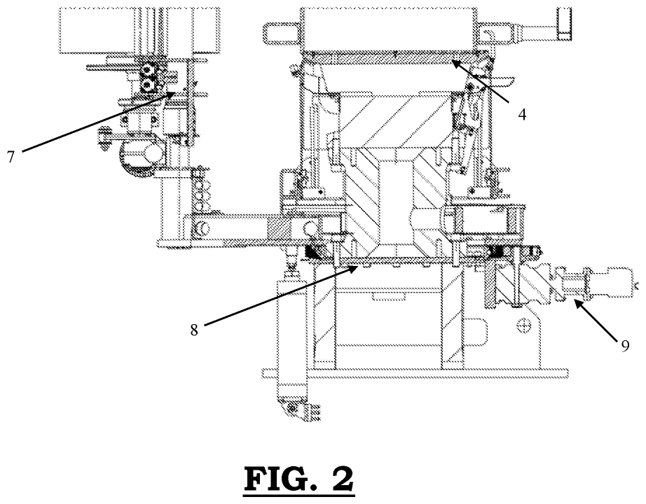

FIG. 2 shows a detail of FIG. 1. The film wrapper (7) is connected to the rotary ring (8) fitted below the bottom ram (4). Said rotary ring is mounted on the bottom frame of the baler device. The rotary ring (8) is driven by the electric motor (9). The setup of the film wrapper (7) connected to the rotary ring (8) fitted below the bottom ram (4) is sufficiently compact so that this can be installed into a single-chamber baler device. This is advantageous for a single-chamber baler device (1) in which the available space for provision of a packaging device is limited.

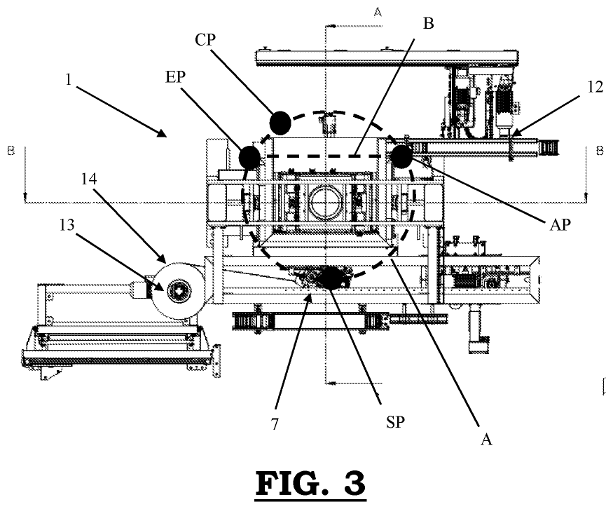

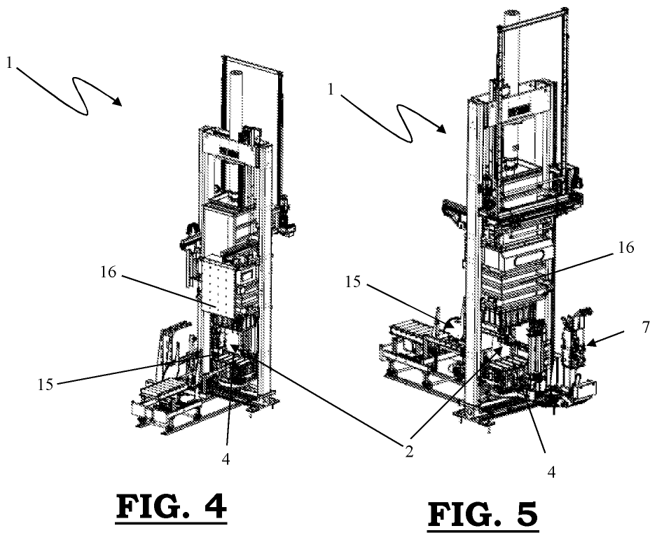

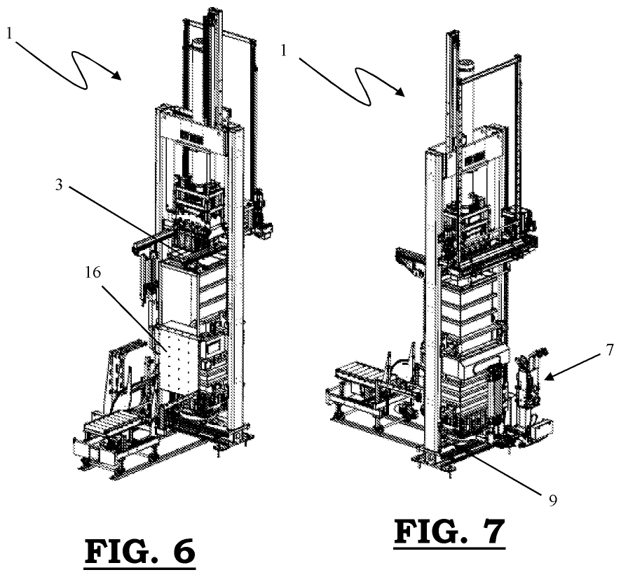

FIG. 3 shows a plan view of a preferred embodiment of the single-chamber baler device (1) according to the disclosure. Here, in addition to a film wrapper (7), the packaging device also comprises a linearly movable translation wrapper (12). FIG. 3 indicates the rotational circle (A) and the linear movement line (B) of the film wrapper (7) and the translation wrapper (12), respectively. The film wrapper (7) is provided with packaging material by the rotatable roll holder (13).

FIG. 3 shows the film wrapper (7) in the start position (SP), which is situated opposite the outfeed side (15) of the pressing and packaging zone (2). The bale has been formed and the adjustable press compartment (16) (not shown here) has been adjusted to the packaging position. A bottom sheet has already been provided between the bale and the bottom ram (4). A top sheet has already been provided between the bale and the top ram (3). The film wrapper (7) rotates anticlockwise from the start position (SP) to the delivery position (AP), at the same time carrying along packaging material from the roll of packaging material (14) provided on the roll holder (13). At the delivery position (AP), the translation wrapper (12) takes over the packaging material from the film wrapper (7). Subsequently, the translation wrapper (12) moves from the delivery position (AP) to the end position (EP). At the end position (EP), the upper and lower gripping devices (10, 11) (not shown here) are activated to clamp the packaging material applied by the translation wrapper (12) between the upper and lower gripping devices (10, 11) and the bale to be packaged. Afterwards, the translation wrapper (12) releases the packaging material. Possibly, the translation wrapper (12) already moves back in the direction of the delivery position (A) in preparation for the next bale to be packaged. After the packaging material has been clamped between the upper and lower gripping devices (10, 11), the film wrapper (7) rotates clockwise from the delivery position (AP) to the end position (EP). At the end position (EP), the upper and lower gripping devices (10, 11) are again activated to clamp the packaging material applied by the film wrapper (7) between the upper and lower gripping devices (10, 11) and the bale to be packaged. Then, the film wrapper (7) rotates to the cutting position (CP) for the cutting off of the packaging material by the cutting device (not shown). After the packaging material has been cut off, the bale can also be tied. For this purpose, the single-chamber baler device (1) may be equipped with a binding device (not shown) that is intended for tying the formed bale using a tying material. The binding device will preferably tie the formed bale using a strap-shaped or wire-shaped tying material, such as for example an iron, steel or plastic wire or strip. An important difference from the baler device described in US 2016/0318640 is that the guiders of the binding device are now provided on the bottom frame instead of forming part of the top structure. The fact that both the rotary ring and the guiders of the binding device are mounted on (or form part of) the bottom frame means that both components can be aligned with respect to one another relatively easily, which is important for simple and compact assembly.

An additional advantage of the baler device (1) according to the disclosure is that a packaged and tied bale can be removed from the device (1) easily and smoothly via the outfeed side (15). A bale is preferably removed with the aid of a movable carriage which is provided with two forks. The forks rotate in order to thus raise the bale, after which the carriage is moved and the bale is thus removed from the pressing and packaging zone of the baler.

FIG. 3 shows the cutting position (CP) just past the end position (EP) in the clockwise direction. It will be clear, however, that the cutting position (CP) may also be situated somewhere else on the rotational circle (A) of the rotation wrapper (7).

1. Single-chamber baler device intended for forming and, by way of a packaging material, packaging bales composed of a compressible material in the form of natural and/or synthetic fibers, comprising: a pressing and packaging zone, a packaging device configured for packaging a bale in the pressing and packaging zone, a top ram and a bottom ram, wherein the material is formed into a bale in the pressing and packaging zone between the top ram and the bottom ram, wherein the pressing and packaging zone is provided with an outfeed side along which a packaged bale exits the pressing and packaging zone, and wherein the packaging device comprises a film wrapper which is rotatable clockwise and anticlockwise and which is intended for packaging one part of the bale by way of anticlockwise rotation of the film wrapper around the bale and for packaging another part of the bale by way of clockwise rotation of the film wrapper around the bale, wherein the film wrapper is rotatable anticlockwise at least between a start position and a delivery position, and is rotatable clockwise between the delivery position and an end position, wherein the single-chamber baler device comprises a vertically adjustable press compartment with a number of press-chamber walls, wherein the adjustable press compartment can be adjusted between a pressing position, in which compressible material can be compressed in the pressing and packaging zone between the top ram, the bottom ram and the press-chamber walls) of the press compartment prior to the formation of a bale, and a packaging position, in which the side walls of the bale formed in the pressing and packaging zone are accessible to the packaging device, and in that the start position of the film wrapper is situated on the side situated opposite the outfeed side of the pressing and packaging zone.

2. Single-chamber baler device according to claim 1, wherein the packaging device comprises a rotary ring mounted below the bottom ram, wherein the film wrapper is connected to the rotary ring for clockwise and anticlockwise rotation of the film wrapper.

3. Single-chamber baler device according to claim 1, wherein the packaging device comprises drive means for driving the rotary ring.

4. Single-chamber baler device according to claim 1, wherein the packaging device comprises guide means which are intended for guiding the packaging material through the film wrapper during rotation of the film wrapper around the bale.

5. Single-chamber baler device according to claim 1, wherein the packaging device comprises a linearly movable translation wrapper intended for gripping the packaging material at the location of the delivery position and carrying it along in the direction of the end position of the film wrapper in order to package part of the bale.

6. Single-chamber baler device according to claim 1, wherein the device furthermore comprises an upper gripping device, fitted in the top ram, and a lower gripping device, fitted in the bottom ram, wherein the upper gripping device and the lower gripping device are configured for gripping packaging material.

7. Single-chamber baler device according to claim 1, wherein the device furthermore comprises a cutting device intended for cutting the packaging material.

8. Single-chamber baler device according to claim 7, wherein the film wrapper, at the location of its end position (EP), is movable between the end position (EP) and a cutting position (CP).

9. Single-chamber baler device according to claim 1, wherein the device furthermore comprises a binding device intended for tying the packaged bale using a tying material.

10. Method for forming and packaging bales in a single-chamber baler device according to claim 1, the method comprising:
a) providing a bottom sheet of packaging material on the bottom ram for covering a bottom surface of a bale to be formed;
b) placing the press compartment in its pressing position;
c) introducing an amount of compressible material into the press compartment (16);
d) driving the top ram or bottom ram for carrying out a pressing stroke;
e) retracting the top ram;
f) repeating steps c), d), and e) until the press compartment contains a desired amount of compressible material, wherein, after or at the same time that step c) is carried out for the final time, a top sheet of packaging material is provided between the bale to be formed and the top ram before a top surface of a bale to be formed is covered;
g) driving the top ram or bottom ram before a final pressing stroke for the formation of the bale is carried out;
h) moving the press compartment to its packaging position;
i) passing a packaging material from a rotation wrapper to a translation wrapper;
j) covering the upright surfaces of the formed bale by packaging a part of these surfaces by way of an anticlockwise rotational movement of the rotation wrapper and by packaging another part of these surfaces by way of a clockwise rotational movement of the rotation wrapper.

11. Method according to claim 10, wherein step j) further comprises covering the upright surfaces of the formed bale by packaging a part of these surfaces by way of a rectilinear movement of the translation wrapper and by packaging another part of these surfaces by way of a rotational movement of the rotation wrapper.
